(19) United States
(12) Patent Application Publication
(10) Pub. No.: US 2015/0163669 A1
(43) Pub. Date: Jun. 11, 2015

(54) SECURITY MECHANISM FOR EXTERNAL CODE

(71) Applicants: Silke Holtmanns, Klaukkala (FI); Pekka Johannes Laitinen, Helsinki (FI)

(72) Inventors: Silke Holtmanns, Klaukkala (FI); Pekka Johannes Laitinen, Helsinki (FI)

(21) Appl. No.: 14/354,904

(22) PCT Filed: Oct. 31, 2011
(86) PCT No.: PCT/FI2011/050953

§ 371 Date: Jun. 30, 2014

(51) Int. Cl. H04W 12/04; H04L 29/06

(52) U.S. Cl. CPC H04W 12/04; H04L 63/08; H04L 63/166

(57) ABSTRACT

A method for providing a security mechanism for an external code, wherein the method includes receiving the external code comprising a request for a server specific bootstrapping key (Ks_NAF). The method further comprises determining a server identifier (NAF-Id) and a security token. Furthermore, the method comprises generating the server specific bootstrapping key (Ks_NAF) based on the server identifier (NAF-Id), and generating an external code specific bootstrapping key (Ks_js_NAF) using the server specific bootstrapping key (Ks_NAF) and the security token. The method also comprises using the external code specific bootstrapping key (Ks_js_NAF) for the security mechanism of the external code.

### TECHNICAL FIELD

The present invention generally relates to security mechanism for an external code provided by an application web server. The invention relates particularly, though not exclusively, to how a server, a phone browser and an operating system may enable secure usage of cellular based credentials from a browser via the external code, such as JavaScript code.

### BACKGROUND ART

Today, many worldwide web pages (e.g. HTML documents) are available that offer a variety of textual and non-textual content types. At the same time, the field of communications, and more specifically wireless telecommunications, is currently undergoing a radical expansion. This technological expansion allows a small, handheld, electronic device, such as a personal digital assistant (PDA), laptop, cellular telephone, tablet, and other electronic devices, to connect to the same information sources, such as a web server or database, as one could with a personal computer (PC) and a PC-based browser. Several small device client browsers are available which display content from the web to the handheld devices.

Scripting commands within web content such as an HTML document, written in JavaScript or a similar scripting language, are used. Scripting commands executed on a PC-based browser may generate some or all of the information content available to a user of the PC-based browser.

The new multimedia capable mobile terminals (multimedia phones) provide an open development platform for application developers, allowing independent application developers to design new services and applications for the multimedia environment. The users may, in turn, download the new applications/services to their mobile terminals and use them therein. Hence, interaction of a security management module of the mobile terminal with an application web server is important for the overall security. An improved solution for using the security management module of the mobile terminal, for web content comprising external code, such as JavaScript, retrieved from an external source, is needed.

### SUMMARY

According to a first example aspect of the invention there is provided a method for providing a security mechanism for an external code, the method comprising:
receiving the external code comprising a request for a server specific bootstrapping key (Ks_NAF);
determining a server identifier (NAF-Id) and generating the server specific bootstrapping key (Ks_NAF) based on the server identifier (NAF-Id);
determining a security token;
generating an external code specific bootstrapping key (Ks_js_NAF) using the server specific bootstrapping key (Ks_NAF) and the security token; and
using the external code specific bootstrapping key (Ks_js_NAF) for the security mechanism of the external code.

In an embodiment, the method further comprises determining the security token using a first random challenge (RAND1) and a second random challenge (RAND2). The method may further comprise transmitting the second random challenge (RAND2) and the external code specific bootstrapping key (Ks_js_NAF) to an application server for validation of the external code specific bootstrapping key (Ks_js_NAF). A response external code comprising the second random challenge (RAND2) and the external code specific bootstrapping key (Ks_js_NAF) may be transmitted.

In an embodiment, the method further comprises:
receiving the external code, by a browser application of an apparatus, from an application server;
determining the server identifier (NAF-Id) and the second random challenge (RAND2), by an application programming interface (JS-GBA-API) of the browser application;
requesting the server specific bootstrapping key (Ks_NAF) by the application programming interface (JS-GBA-API), from a bootstrapping module of the operating system;
receiving the server specific bootstrapping key (Ks_NAF) by the application programming interface (JS-GBA-API), from the bootstrapping module; and
generating the external code specific bootstrapping key (Ks_js_NAF) by the application programming interface (JS-GBA-API).

A transport layer security (TLS) tunnel may be established between a browser application of an apparatus and an application server. The server identifier (NAF-Id) may be determined including a domain name (FQDN) and a security protocol identifier. The security protocol identifier may be formed using a ciphersuite of a transport layer security (TLS).

In an embodiment, the method further comprises generating the external code specific bootstrapping key (Ks_js_NAF) with a key derivation function. The external code may comprise a JavaScript code.

In an embodiment, the method further comprises determining the security token using a transport layer security (TLS) master key.

According to a second example aspect of the invention there is provided an apparatus, comprising:
at least one processor; and
at least one memory including computer program code, the at least one memory and the computer program code being configured to, with the at least one processor, cause the apparatus at least to:
receive an external code comprising a request for a server specific bootstrapping key (Ks_NAF);
determine a server identifier (NAF-Id) and generate the server specific bootstrapping key (Ks_NAF) based on the server identifier (NAF-Id);
determine a security token;
generate an external code specific bootstrapping key (Ks_js_NAF) using the server specific bootstrapping key (Ks_NAF) and the security token; and
use the external code specific bootstrapping key (Ks_js_NAF) for a security mechanism of the external code.

The security token may be determined using a first random challenge (RAND1) and a second random challenge (RAND2).

In an embodiment, the at least one memory and the computer program code being further configured to, with the at least one processor, cause the apparatus at least to:
receive the external code, by a browser application of the apparatus, from an application server;
determine the server identifier (NAF-Id) by an application programming interface (JS-GBA-API) of the browser application;
request the server specific bootstrapping key (Ks_NAF) by the application programming interface (JS-GBA-API), from a bootstrapping module of the operating system;
receive the server specific bootstrapping key (Ks_NAF) by the application programming interface (JS-GBA-API), from the bootstrapping module; and
generate the external code specific bootstrapping key (Ks_js_NAF) by the application programming interface (JS-GBA-API).

The server identifier (NAF-Id) may be determined by including a domain name (FQDN) and a security protocol identifier.

In an embodiment, the security token may be determined using a transport layer security (TLS) master key.

According to a third example aspect of the invention there is provided a computer program embodied on a computer readable medium comprising computer executable program code which, when executed by at least one processor of an apparatus, causes the apparatus to:
receive an external code comprising a request for a server specific bootstrapping key (Ks_NAF);
determine a server identifier (NAF-Id) and generate a server specific bootstrapping key (Ks_NAF) based on the server identifier (NAF-Id);
determine a security token;
generate an external code specific bootstrapping key (Ks_js_NAF) using the server specific bootstrapping key (Ks_NAF) and the security token; and
use the external code specific bootstrapping key (Ks_js_NAF) for a security mechanism of the external code.

According to a fourth example aspect of the invention there is provided a method for providing a security mechanism for an external code, the method comprising:
transmitting the external code, wherein the external code comprising a request for a server specific bootstrapping key (Ks_NAF);
determining a security token;
generating the server specific bootstrapping key (Ks_NAF) using a server identifier (NAF-Id);
generating an external code specific bootstrapping key (Ks_js_NAF) using the server specific bootstrapping key (Ks_NAF) and the security token; and
using the external code specific bootstrapping key (Ks_js_NAF) for the security mechanism of the external code.

In an embodiment, the method further comprising:
requesting the server specific bootstrapping key (Ks_NAF) from a bootstrapping server function (BSF); and
determining the server identifier (NAF-Id) including a domain name (FQDN) and a security protocol identifier.

In an embodiment, the method further comprising:
receiving an external code specific bootstrapping key (Ks_js_NAF); and
validating the generated external code specific bootstrapping key (Ks_js_NAF) by comparing to the received external code specific bootstrapping key (Ks_js_NAF) for the security mechanism of the external code.

According to a fifth example aspect of the invention there is provided an application server, comprising:
at least one processor; and
at least one memory including computer program code, the at least one memory and the computer program code being configured to, with the at least one processor, cause the application server at least to:
transmit an external code, wherein the external code comprising a request for a server specific bootstrapping key (Ks_NAF);
generate a server specific bootstrapping key (Ks_NAF) using a server identifier (NAF-Id);
determine a security token;
generate an external code specific bootstrapping key (Ks_js_NAF) using the server specific bootstrapping key (Ks_NAF) and the security token; and
use the external code specific bootstrapping key (Ks_js_NAF) for the security mechanism of the external code.

In an embodiment, the at least one memory and the computer program code being further configured to, with the at least one processor, cause the application server at least to:
generate the server specific bootstrapping key (Ks_NAF) by requesting from a bootstrapping server function (BSF).

According to a sixth example aspect of the invention there is provided a computer program embodied on a computer readable medium comprising computer executable program code which, when executed by at least one processor of an application server, causes the application server to:
transmit an external code, wherein the external code comprising a request for a server specific bootstrapping key (Ks_NAF);
generate a server specific bootstrapping key (Ks_NAF) using a server identifier (NAF-Id);
determine a security token;
generate an external code specific bootstrapping key (Ks_js_NAF) using the server specific bootstrapping key (Ks_NAF) and the security token; and
use the external code specific bootstrapping key (Ks_js_NAF) for the security mechanism of the external code.

Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

Different non-binding example aspects and embodiments of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

The invention will be described, by way of example only, with reference to the accompanying drawings, in which:

FIG. 1 shows some details of the system architecture in which various embodiments of the invention may be applied;

FIG. 2 shows some details of the system elements, in which various embodiments of the invention may be applied;

FIG. 3 shows a messaging diagram according to an embodiment of the invention;

FIG. 4 presents an example block diagram of an application server in which various embodiments of the invention may be applied;

FIG. 5 presents an example block diagram of a user apparatus in which various embodiments of the invention may be applied;

FIG. 6 shows a flow diagram showing operations in a user apparatus in accordance with an example embodiment of the invention; and

FIG. 7 shows a flow diagram showing operations in an application server in accordance with an example embodiment of the invention.

### DETAILED DESCRIPTION

In the following description, like numbers denote like elements.

Various embodiments of the invention employ features of a Generic Authentication Architecture (GAA) and Generic Bootstrapping Architecture (GBA) defined in 3GPP for peer authentication and communication security. Variants of GAA/GBA are standardized by Open Mobile Alliance (OMA) and CableLabs. GAA/GBA is based on mobile algorithms AKA (Authentication and Key Agreement) for 3GPP. The original purpose of the GAA/GBA procedures is to authenticate user equipment or a subscriber. Now in various embodiments of the invention, the GAA/GBA is used for improving security between an application server, a mobile terminal browser and an operating system of the mobile terminal. In an embodiment secure usage of cellular based credentials is enabled from the browser via an external code that is downloaded from a server to the user apparatus within a webpage, for example. The external code may comprise a JavaScript code, for example.

An advantage that may be achieved by using the authentication mechanisms of GAA/GBA for authenticating application servers is that one may avoid the use of an expensive Public Key Infrastructure that might otherwise be needed. GAA/GBA is a multipurpose enabler that is used for example for Mobile TV and presence. By using this existing mechanism and associated infrastructure one may achieve the benefit that administrative costs and the amount of investment that needs to be made may be reduced.

In the following description terms like user apparatus, application server, bootstrapping server, and generic authentication procedure are used for referring to various elements/mechanisms relating to the various embodiments of the invention. It must be noted that in addition to or instead of those explicit elements/mechanisms some other element(s)/mechanism(s) providing comparable functionality may be used.

In various embodiments of the invention an application server may be a web server providing a web service for a user. The application server may also be untrusted by the network operator and comprise a network application function (NAF).

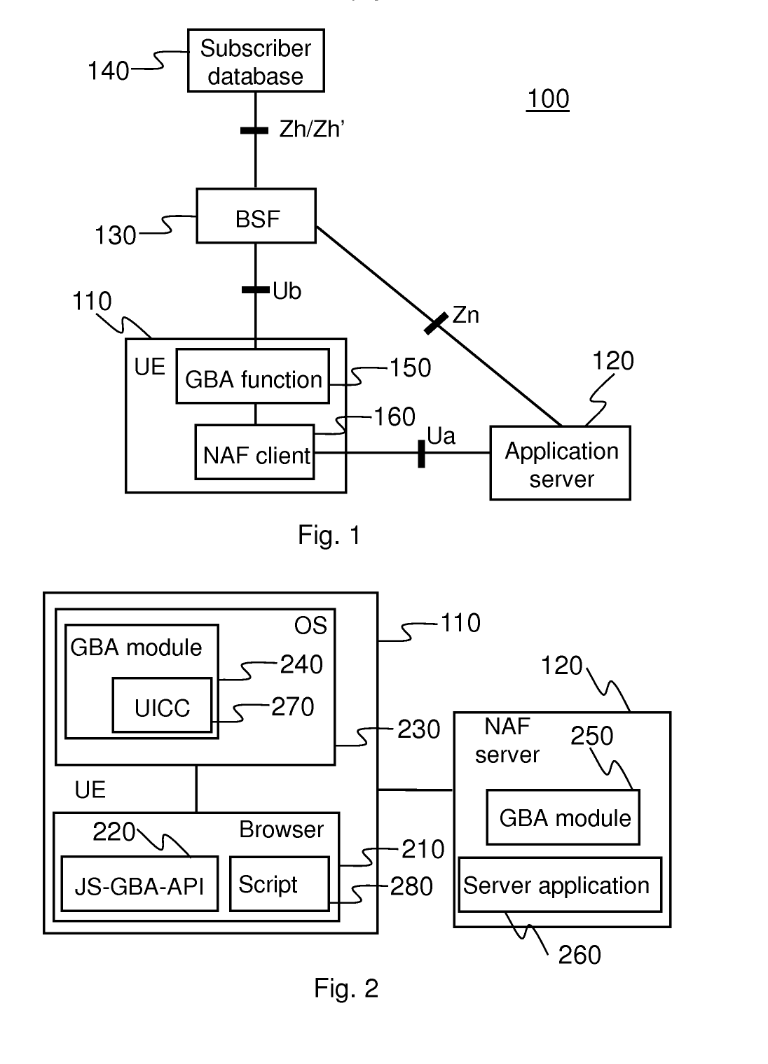

FIG. 1 shows some details of the system architecture 100, in which various embodiments of the invention may be applied. The system comprises a user apparatus, such as a user equipment (UE) 110, and an application server 120 providing web service(s). Additionally the system comprises a bootstrapping server function (BSF) 130 and a subscriber database 140, such as a home subscriber server (HSS) or home location register (HLR). The apparatus 110 further comprises a GBA (Generic Bootstrapping Architecture) function block 150 configured to co-operate with the bootstrapping server function (BSF) and a network application function (NAF) client 160 configured to co-operate with the application server 120. The network application function (NAF) client may comprise for example a browser. In GAA/GBA an application server may be referred to as a network application function (NAF). There is a Zh interface defined in GAA/GBA between the bootstrapping server function (BSF) 130 and the subscriber database 140, a Zn interface between the bootstrapping server function (BSF) 130 and the application server 120, and Ub interface between the bootstrapping server function (BSF) 130 and the user apparatus 110. Additionally, there may be a Zh′ interface between the bootstrapping server function (BSF) 130 and HLR 140, if a HLR is deployed. Additionally, there may be an interface to a subscription locator function (SLF) that provides subscriber database information to the bootstrapping server function (BSF).

The application server 120 may be administered by a different party compared to the bootstrapping server function (BSF) 130 and subscriber database 140, or they may be administered by the same party (which is typically the operator of the communication network in question).

It must be noted that the system 100 may, and usually does, comprise various other elements as well, but they are not shown here for the sake of clarity.

In an embodiment, a generic bootstrapping server function (BSF) 130 and the user equipment (UE) 110 shall mutually authenticate using the authentication and key agreement (AKA) protocol, and agree on keys that are afterwards applied between user equipment (UE) 110 and a network application function (NAF) of a server 120. The network application function (NAF) is a functional module located in the service providing server 120. Alternatively, if a legacy smart card is involved, transport layer security (TLS) and legacy authentication may be used. Generic bootstrapping architecture (GBA) may also utilize other authentication mechanism, like hypertext transfer protocol (HTTP) digest or session initiation protocol (SIP) digest. Main functions of the network application function (NAF) module of the server 120 are service/user management (e.g., service subscription and unsubscription) and service key management (e.g., service key generation and delivery). The bootstrapping server function (BSF) 130 shall restrict the applicability of the key material to a specific network application function (NAF) of a server 120 by using a key derivation procedure. The key derivation procedure may be used with multiple network application functions (NAF) during the lifetime of the key material. The lifetime of the key material is set according to the local policy of the bootstrapping server function (BSF) 130. The bootstrapping server function (BSF) 130 is allowed to fetch any required authentication information, security information and subscriber profile information from a home subscriber system (HSS) 140. In legacy networks the bootstrapping server function (BSF) 130 may interact with the home location register (HLR) instead of the home subscriber system (HSS) 140.

There may be a concern, by e.g. operators, relating to the GBA usage from an external code, such as a script code like JavaScript, for example. The external code may be downloaded to the user apparatus and the concern may be that the secret of the GBA module is sent to the web server as-is.

FIG. 2 shows some details of the system elements, in which various embodiments of the invention may be applied. The external code may comprise any code downloaded to an apparatus and potentially used or executed locally. The external codes may be executed in installed applications, such as browsers or widgets, for example. One example of external codes is JavaScript code. For simplicity, the following example embodiments are described using the JavaScript but the embodiments are not limited to JavaScript and any external code may apply.

JavaScript may be used in the form of client-side JavaScript processed in a user equipment (UE) 110. Running JavaScript 280 may be implemented as part of a web browser 210 in order to provide enhanced user interfaces and dynamic websites. This enables programmatic access to computational objects within a host environment. The JavaScript 280 may be also used in applications outside web pages, for example in documents, site-specific browsers, and desktop widgets. JavaScript is also used for server-side web applications. An application programming interface (API) is a particular set of rules (‘code’) and specifications that software programs can follow to communicate with each other. API serves as an interface between different software programs and facilitates their interaction. For the JavaScript 280, a GBA API may be created, named as JS-GBA-API 220 in FIG. 2. Operating system (OS) 230 of the user equipment (UE) 110 may comprise a GBA module 240 that is responsible for the security management of the user equipment (UE) 110. The user equipment (UE) 110 may also comprise a universal integrated circuit card (UICC) 270 that is a smart card used in mobile terminals in cellular networks. The universal integrated circuit card (UICC) 270 ensures the integrity and security of all kinds of personal data, and it typically contains applications. UICC smart card may also comprise a CPU, ROM, RAM, EEPROM and I/O circuits.

The browser 210 of the user equipment (UE) 110 may communicate with a network application function (NAF) server 120 operating as an application service server for web content, for example. The network application function (NAF) server 120 may comprise a GBA NAF module 250 and a server application 260, for example.

In an embodiment, the interaction of a user apparatus security management module (GBA module, that is part of the OS) with an application web server is provided. The security mechanism enables a secure usage of the security management module 240 from a browser 210 with JavaScript 280 coming from an external source 120.

When referring to GBA keys, the following keys are intended: Ks and NAF specific keys derived from the Ks. When referring to NAF specific keys, the following keys are intended: Ks_ext/int_NAF (in GBA_U context) and Ks_NAF (in GBA_ME context), and any keys derived from these keys. Ks_ext_NAF is the same key as Ks_NAF, i.e., the NAF specific key used in the ME. The Ks_ext_NAF is derived in the UICC in GBA_U context and given to the ME, and Ks_NAF is derived in the ME in GBA_ME context. They may be both used the same way in the ME regardless of the context. The Ks_int_NAF is derived in the UICC and it is used in the UICC. The Ks_int_NAF is never given out from the UICC. When referring to Ks_js_NAF key, the JavaScript key for the JavaScript code and the application server used instead of Ks_NAF or Ks_ext_NAF is intended.

In an embodiment, before communication between the UE and the network application function (NAF) can start, the UE and the network application function (NAF) first have to agree whether to use the GBA. When a UE wants to interact with a network application function (NAF), but it does not know if the network application function (NAF) requires the use of shared keys obtained by means of the GBA, the UE shall contact the network application function (NAF) for further instructions.

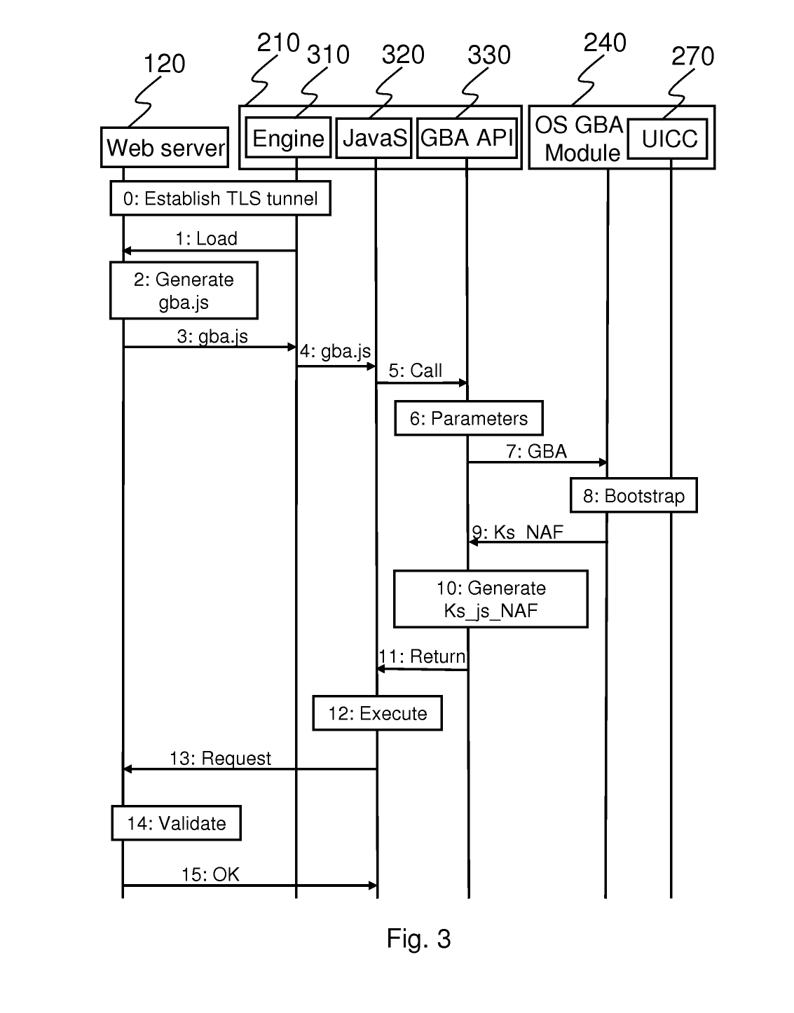

FIG. 3 shows a messaging diagram according to an embodiment of the invention. Not all messages and items showed, need to be performed, order of messages may vary, and more messages may be performed, not limiting to those messages and items showed in FIG. 3.

A user apparatus, such as a user equipment (UE) may start communication over reference point Ua with an application server, such as network application function (NAF) server without any generic bootstrapping architecture (GBA) related parameters. If the NAF requires the use of shared keys obtained by means of the GBA, but the request from UE does not include GBA related parameters, the network application function (NAF) replies with a bootstrapping initiation message. The form of this indication may depend on the particular reference point Ua.

In an embodiment, a web browser 210 is considered to be a trusted application in the sense that a user trusts the browser 210 to handle security related functions properly and not leaking sensitive information like passwords to third parties. In the FIG. 3, the web browser 210 is divided into three functional blocks: An engine module 310, a JavaScript module 320 and a GBA-API module 330.

The engine module 310 handles basic functionalities for the web browser 210 like setting up transport layer security (TLS) with web servers 120, downloading web resources, and providing user interface information for the user.

The GBA API module 330 offers the application programming interface (API) towards any JavaScript code executing in the web browser 210. As JavaScript should not be explicitly trusted, the web browser 210 and the GBA API 330 should not reveal any sensitive information to the JavaScript, nor should they accept any sensitive information from the JavaScript more than necessary.

The JavaScript module 320 executes the downloaded JavaScript. Any JavaScript code executed in the web browser 210 should be considered not trusted and should not be granted access to sensitive resources or the access to such resources should be controlled.

The depicted sequence flow diagram of FIG. 3 may be executed within a server authenticated transport layer security (TLS). Also, the web browser 210 may be in the process of downloading a html page, in which one of the linked JavaScript resources is called “gba.js”.

In item 0, the browser application 210 and the web server 120 establish a server authenticated transport layer security (TLS) tunnel.

In item 1 of FIG. 3, a content download is requested by a browser application 210 of a user apparatus, such as a user equipment (UE). The content may be, for example a web page provided by an application server 120, such as a web server. The request of item 1 may comprise for example a HTTP request.

In item 2 of FIG. 3, the web server 120 dynamically constructs the JavaScript code “gba.js” file by generating a server random challenge (RAND1) that is to be included to the JavaScript code and provided to GBA API 330 of the browser 210. The RAND1 is also locally stored in the web server 120. In this JavaScript code, a JavaScript GBA application programming interface (API) 220 may be used to request and obtain a JavaScript specific GBA key (Ks_js_NAF). A random challenge RAND1 is included in the GBA API request in item 2. The JavaScript specific GBA key (Ks_js_NAF) request may also be forwarded to the GBA module 240 when received at the browser 210 and forwarded by the GBA module 240 to the GBA API 220 for further processing.

The web page with a JavaScript code 280 is loaded from the server 120 in item 3, as a HTTP response, for example. In item 4, the engine 310 of the web browser 210 starts to execute the JavaScript code “gba.js” in the JavaScript module 320.

In item 5, the JavaScript code “gba.js” comes to a point where a call to GBA API 330 is made. The call contains RAND1 as one of the parameters. In item 6, the JavaScript GBA API 330 stores the received RAND1. The GBA API 330 also locates the relevant information about the JavaScript code, for example what html page it is executing, from what url was the html page downloaded from, and which TLS ciphersuite is used in the TLS tunnel. A domain name (FQDN) of the web server (NAF) 120 may be extracted from the url of the web page, and the Ua security protocol identifier can be derived from the used TLS ciphersuite. The domain name (FQDN) of the NAF server 120 and the Ua security protocol identifier form the network application function identifier (NAF-Id).

In item 7, the GBA API module 330 makes a call to the GBA module 240 with the NAF-Id derived in item 6. In item 8, the GBA module 240 bootstraps with the bootstrapping function (BSF), in case there is no valid GBA master key Ks. From the Ks a NAF specific key (Ks_ext_NAF) is derived using the NAF-Id.

In GBA_ME case, the UICC 270 gives the CK and IK to the GBA module 240, which generates Ks from them by concatenating CK and IK, for example. Furthermore, the GBA module 240 generates the Ks_NAF using the Ks NAF-Id.

In GBA_U case, the UICC 270 keeps the CK and IK to itself, and generates the Ks_ext_NAF, which is then given to the GBA module 240.

Thus, in GBA_ME case all GBA specific functionality is implemented in the ME, and in GBA_U case part of the GBA functionality is implemented in the UICC 270. Mainly Ks is kept in the UICC 270 and only the derived Ks_(ext)_NAF is given to the GBA Module 240. In other words, GBA “master key” Ks is either generated in the ME (GBA_ME case) or in the UICC 270 (GBA_U case).

An application getting a required GBA key only deals with the GBA Module 240, and the GBA key is either Ks_NAF in GBA_ME case and Ks_ext_NAF in GBA_U case, respectively. The application may then use the GBA key Ks_(ext)_NAF, regardless of the source.

In item 9, the GBA module 240 returns the NAF specific key (Ks_ext_NAF) to browser's GBA API 330 with a bootstrapping transaction identifier (B-TID), and key lifetime, for example. In item 10, the GBA API 330 may generate a client side random challenge RAND2. A security token may be determined using random challenge RAND1 and random challenge RAND2. Furthermore, a JavaScript specific GBA key (Ks_js_NAF) is created using the server specific bootstrapping key (Ks_ext_NAF) and the security token (random challenges RAND1 and RAND2). A key derivation function (KDF) may be used to produce the JavaScript specific GBA key as following:

Ks_{—}js_NAF=KDF(Ks_ext_NAF,RAND1∥RAND2)

The RAND1 is the random challenge received from the server 120 and RAND2 is generated by the GBA API 330. The Ks_(ext)_NAF may be processed to the GBA API 330 in JavaScript level. The JavaScript function may be called for example GBA.getNAFKey(RAND1) and the function then returns Ks_js_NAF and RAND2.

In item 11, the GBA API 330 returns JavaScript specific Ks_js_NAF key, RAND2, B-TID and key lifetime to the executing JavaScript module 320. The JavaScript module 320 continues, in item 12, to execute and uses the Ks_js_NAF key the way web server 120 has instructed (via JavaScript code “gba.js”).

In item 13, after executing the client side logic, the JavaScript module 320 makes a request (e.g. HTTP request) to the web server 120. This request may contain at least Ks_js_NAF, RAND2, and B-TID.

In item 14, the web server 120 may fetch the Ks_ext_NAF from the bootstrapping function (BSF), and then derive the Ks_js_NAF with the received RAND2 and the stored RAND1. The web server 120 may compare the received Ks_js_NAF with the locally derived one for validation. If the received Ks_js_NAF is valid, the web server 120 will continue to process the request made in item 13 and return the result to the JavaScript module 320 of the web browser 120 in item 15. Furthermore, the web server 120 may continue to execute the JavaScript code.

In an embodiment, the NAF specific key (Ks_NAF) is not sent to server as such, which improves the security mechanism. Furthermore, the JavaScript specific key (Ks_js_NAF) is changed every time the GBA API 330 is used, because RAND1 and RAND2 are changed. Such mechanism provides further security and replay protection, for example.

In another embodiment, a different security token is used. In such embodiment, in item 2 of FIG. 3, the web server 120 selects the JavaScript code “gba.js” file to be provided to GBA API 330 of the browser 210. In this JavaScript code, a JavaScript GBA application programming interface (API) 220 may be used to request and obtain a JavaScript specific GBA key (Ks_js_NAF). The JavaScript specific GBA key (Ks_js_NAF) request may also be forwarded to the GBA module 240 when received at the browser 210 and forwarded by the GBA module 240 to the GBA API 220 for further processing.

The web page with a JavaScript code 280 is loaded from the server 120 in item 3, as a HTTP response, for example. In item 4, the engine 310 of the web browser 210 starts to execute the JavaScript code “gba.js” in the JavaScript module 320.

In item 5, the JavaScript code “gba.js” comes to a point where a call to GBA API 330 is made. In item 6, the JavaScript GBA API 330 locates the relevant information about the JavaScript code, for example what html page it is executing, from what url was the html page downloaded from, and which transport layer security (TLS) ciphersuite is used in the TLS tunnel. A domain name (FQDN) of the web server (NAF) 120 may be extracted from the url of the web page, and the Ua security protocol identifier can be derived from the used TLS ciphersuite. The domain name (FQDN) of the NAF server 120 and the Ua security protocol identifier form the network application function identifier (NAF-Id).

In item 7, the GBA API module 330 makes a call to the GBA module 240 with the NAF-Id derived in item 6. In item 8, the GBA module 240 bootstraps with the bootstrapping function (BSF), in case there is no valid GBA master key Ks. From the Ks a NAF specific key (Ks_ext_NAF) is derived using the NAF-Id.

In GBA_ME case, the UICC 270 gives the CK and IK to the GBA module 240, which generates Ks from them by concatenating CK and IK, for example. Furthermore, the GBA module 240 generates the Ks_NAF using the Ks NAF-Id.

In GBA_U case, the UICC 270 keeps the CK and IK to itself, and generates the Ks_ext_NAF, which is then given to the GBA module 240.

Thus, in GBA_ME case all GBA specific functionality is implemented in the ME, and in GBA_U case part of the GBA functionality is implemented in the UICC 270. Mainly Ks is kept in the UICC 270 and only the derived Ks_(ext)_NAF is given to the GBA Module 240. In other words, GBA “master key” Ks is either generated in the ME (GBA_ME case) or in the UICC 270 (GBA_U case).

An application getting a required GBA key only deals with the GBA Module 240, and the GBA key is either Ks_NAF in GBA_ME case and Ks_ext_NAF in GBA_U case, respectively. The application may then use the GBA key Ks_(ext)_NAF, regardless of the source.

In item 9, the GBA module 240 returns the NAF specific key (Ks_(ext)_NAF) to browser's GBA API 330 with a bootstrapping transaction identifier (B-TID), and key lifetime, for example. In item 10, upon receiving the Ks_(ext)_NAF key, the browser's GBA API 330 may determine a security token. The security token (TLS_{—} MK_Extr) may be extracted from the transport layer security (TLS) master key using an exported function. The label for the exported function may be “EXPORTER_{—}3GPP_GBA_WEB”, for example. The security token (TLS_MK_Extr) may be used to derive a JavaScript specific key Ks_js_NAF that is bound to the server authenticated TLS tunnel. The Ks_js_NAF may be derived from the Ks_(ext)_NAF as follows:

Ks_{—}js_NAF=KDF(Ks_(ext)_NAF,TLS_{—}MK_Extr)

The JavaScript specific GBA key (Ks_js_NAF) is created using the server specific bootstrapping key Ks_(ext)_NAF and the security token (TLS_ML_Extr). A key derivation function (KDF) may be used to produce the JavaScript specific GBA key. The Ks_(ext)_NAF may be processed to the GBA API 330 in JavaScript level.

In item 11, the GBA API 330 returns JavaScript specific Ks_js_NAF key, B-TID and key lifetime to the executing JavaScript module 320. The JavaScript module 320 continues, in item 12, to execute and uses the Ks_js_NAF key the way web server 120 has instructed (via JavaScript code “gba.js”).

In item 13, after executing the client side logic, the JavaScript module 320 makes a request (e.g. HTTP request) to the web server 120. This request may contain at least Ks_js_NAF and B-TID.

In item 14, the web server 120 may fetch the Ks_(ext)_NAF from the bootstrapping function (BSF) and determine the security token (TLS_MK_Extr), as done in item 10. The web server 120 may then derive the Ks_js_NAF with the security token (TLS_MK_Extr). The web server 120 may compare the received Ks_js_NAF with the locally derived one for validation. If the received Ks_js_NAF is valid, the web server 120 will continue to process the request made in item 13 and return the result to the JavaScript module 320 of the web browser 120 in item 15. Furthermore, the web server 120 may continue to execute the JavaScript code.

In an embodiment, the NAF specific key (Ks_NAF) is not sent to server as such, which improves the security mechanism.

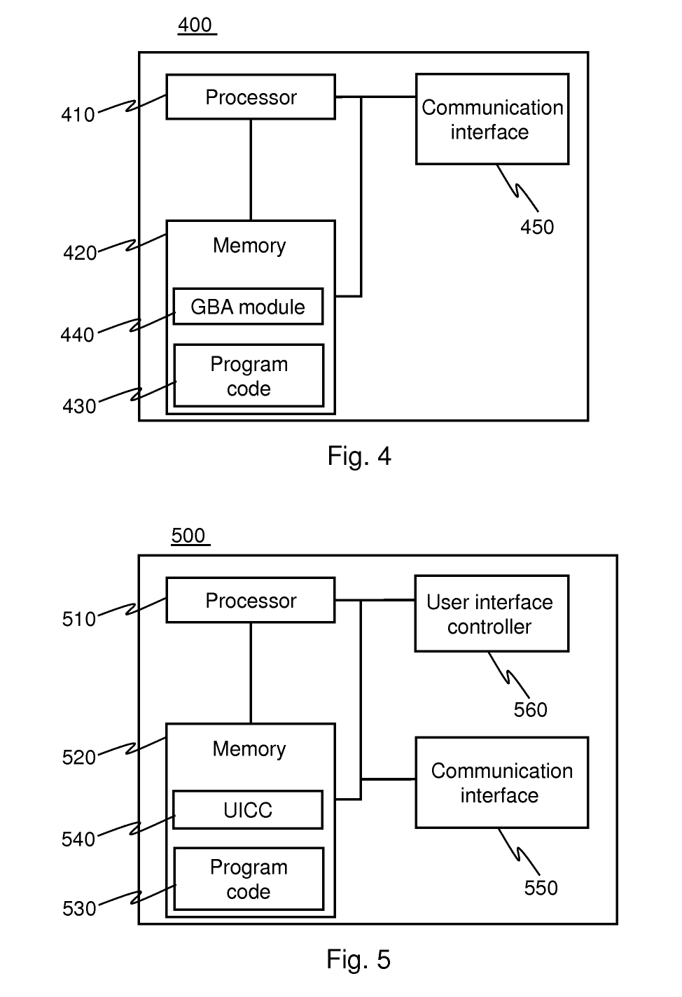

FIG. 4 presents an example block diagram of an application server 400 in which various embodiments of the invention may be applied. This may be a web server, a file download server or any content providing server.

The general structure of the application server 400 comprises a communication interface module 450, a processor 410 coupled to the communication interface module 450, and a memory 420 coupled to the processor 410. The apparatus further comprises software 430 stored in the memory 420 and operable to be loaded into and executed in the processor 410. The software 430 may comprise one or more software modules and can be in the form of a computer program product.

The communication interface module 450 implements at least part of the data transmission discussed in connection with various embodiments of the invention. The communication interface module 450 may be, e.g., a radio interface module, such as a WLAN, Bluetooth, GSM/GPRS, CDMA, WCDMA, or LTE (Long Term Evolution) radio module. The communication interface module 450 may be integrated into the application server 400 or into an adapter, card or the like that may be inserted into a suitable slot or port of the application server 400. The communication interface module 450 may support one radio interface technology or a plurality of technologies. FIG. 4 shows one communication interface module 450, but the application server 400 may comprise a plurality of communication interface modules 550. The communication interface module 450 provides data communication, for example, with a bootstrapping function (BSF), a home subscriber server (HSS), and an external content server.

The processor 410 may be, e.g., a central processing unit (CPU), a microprocessor, a digital signal processor (DSP), a graphics processing unit, or the like. FIG. 4 shows one processor 410, but the application server 400 may comprise a plurality of processors.

The memory 420 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The application server 400 may comprise a plurality of memories. The memory 420 may be constructed as a part of the application server 400 or it may be inserted into a slot, port, or the like of the application server 400. The memory 420 may serve the sole purpose of storing data, or it may be constructed as a part of an apparatus serving other purposes, such as processing data.

A general bootstrapping architecture module (GBA) 440 may comprise a network application function (NAF). GBA may be used between the network application function (NAF) and the UE for authentication purposes, and for securing the communication path between the UE and the network application function (NAF). After the bootstrapping has been completed, the UE and the network application function (NAF) can run some application specific protocol where the authentication of messages will be based on those session keys generated during the mutual authentication between the UE and the bootstrapping server function (BSF).

A skilled person appreciates that in addition to the elements shown in FIG. 4, the application server 400 may comprise other elements, such as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like.

FIG. 5 presents an example block diagram of a user apparatus 500 in which various embodiments of the invention may be applied. This may be a user equipment (UE), user device or apparatus, such as a mobile terminal, a laptop, a tablet, or other communication device.

The general structure of the user apparatus 500 comprises a communication interface module 550, a processor 510 coupled to the communication interface module 550, and a memory 520 coupled to the processor 510. The user apparatus further comprises software 530 stored in the memory 520 and operable to be loaded into and executed in the processor 510. The software 530 may comprise one or more software modules and can be in the form of a computer program product. The user apparatus 500 further comprises a user interface controller 560 coupled to the processor 510.

The communication interface module 550 implements at least part of the user data radio discussed in connection with various embodiments of the invention. The communication interface module 550 may be, e.g., a radio interface module, such as a WLAN, Bluetooth, GSM/GPRS, CDMA, WCDMA, or LTE (Long Term Evolution) radio module. The communication interface module 550 may be integrated into the user apparatus 500 or into an adapter, card or the like that may be inserted into a suitable slot or port of the user apparatus 500. The communication interface module 550 may support one radio interface technology or a plurality of technologies. FIG. 5 shows one communication interface module 550, but the user apparatus 500 may comprise a plurality of communication interface modules 550.

The processor 510 may be, e.g., a central processing unit (CPU), a microprocessor, a digital signal processor (DSP), a graphics processing unit, or the like. FIG. 5 shows one processor 510, but the user apparatus 500 may comprise a plurality of processors.

The memory 520 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The user apparatus 500 may comprise a plurality of memories. The memory 520 may be constructed as a part of the apparatus 500 or it may be inserted into a slot, port, or the like of the user apparatus 500 by a user. The memory 520 may serve the sole purpose of storing data, or it may be constructed as a part of an apparatus serving other purposes, such as processing data.

A universal integrated circuit card (UICC) 540 may be included as a smart card used in the user apparatus 500. The universal integrated circuit card (UICC) 540 ensures the integrity and security of certain personal data. The universal integrated circuit card (UICC) 540 may contain its unique serial number, internationally unique number of the mobile user (IMSI), security authentication and ciphering information, temporary information related to the local network, a list of the services the user has access to and passwords (PIN for usual use and PUK for unlocking). The universal integrated circuit card (UICC) 540 may further comprise several applications, making it possible for the same smart card to give access to different networks, and also provide storage of a phone book and other applications. The system may utilize an embedded security module for the key storage and processing.

The user interface controller 560 may comprise circuitry for receiving input from a user of the user apparatus 500, e.g., via a keyboard, graphical user interface shown on the display of the user apparatus 500, speech recognition circuitry, or an accessory device, such as a headset, and for providing output to the user via, e.g., a graphical user interface or a loudspeaker.

A skilled person appreciates that in addition to the elements shown in FIG. 5, the user apparatus 500 may comprise other elements, such as microphones, displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the user apparatus 500 may comprise a disposable or rechargeable battery (not shown) for powering the user apparatus 500 when external power if external power supply is not available.

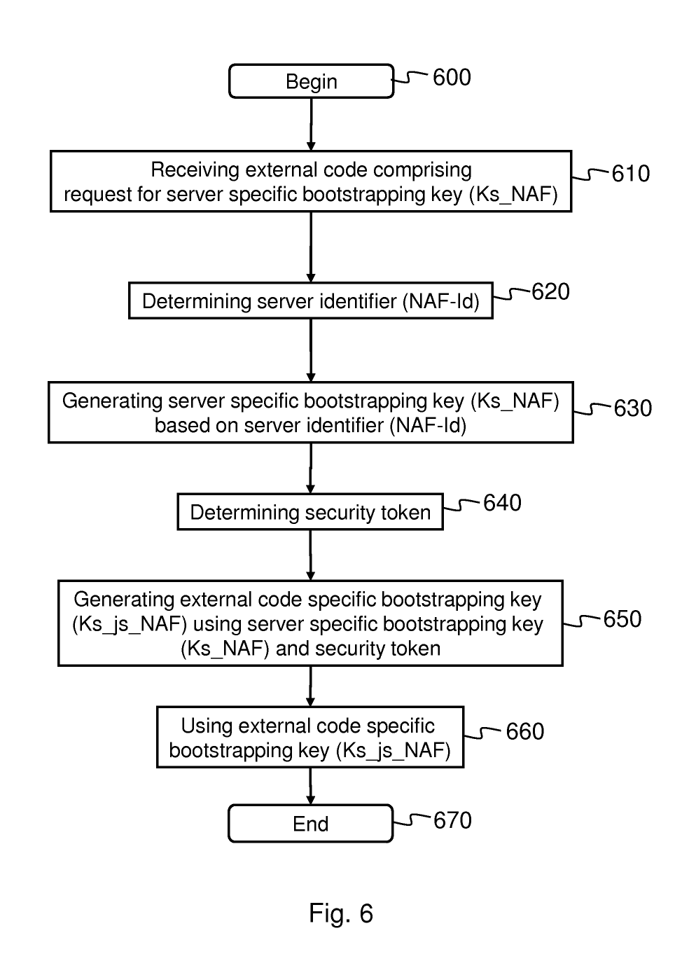

FIG. 6 shows a flow diagram showing operations in a user apparatus in accordance with an example embodiment of the invention. In step 600, the method is started. In step 610, an external code comprising a request for a server specific bootstrapping key (Ks_NAF) is received. In step 620, a server identifier (NAF-Id) is determined. A server specific bootstrapping key (Ks_NAF) is generated based on the server identifier (NAF-Id), in step 630. In step 640, a security token is determined. In step 650, an external code specific bootstrapping key (Ks_js_NAF) is generated using the server specific bootstrapping key (Ks_NAF) and the security token. The external code specific bootstrapping key (Ks_js_NAF) is used for the security mechanism of the external code in step 660. The method ends in step 670.

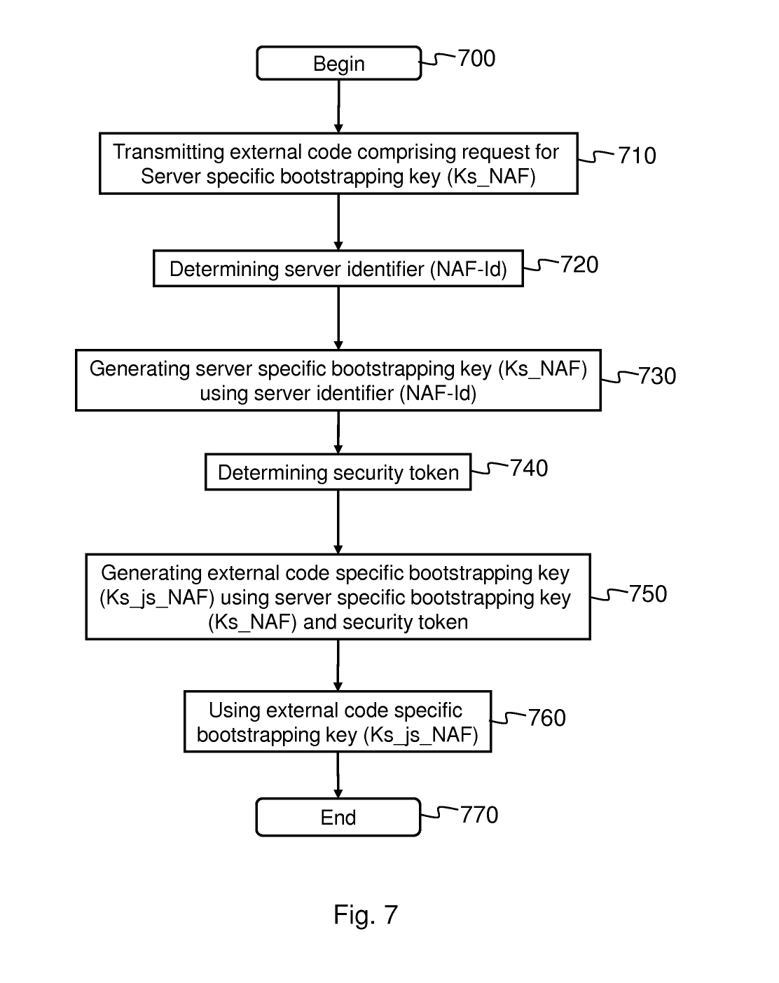

FIG. 7 shows a flow diagram showing operations in an application server in accordance with an example embodiment of the invention. In step 700, the method is started. In step 710, a script code comprising a request for a script code specific bootstrapping key (Ks_js_NAF) is transmitted. A server identifier (NAF-Id) is determined in step 720. In step 730, a server specific bootstrapping key (Ks_NAF) is generated using the server identifier (NAF-Id). In step 740, a security token is determined. In step 740, the script code specific bootstrapping key (Ks_js_NAF) is generated using the server specific bootstrapping key (Ks_NAF) and the security token. The script code specific bootstrapping key (Ks_js_NAF) is used for the security mechanism of the script code in step 760. The method ends in step 770.

Various embodiments have been presented. It should be appreciated that in this document, words comprise, include and contain are each used as open-ended expressions with no intended exclusivity.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1-20. (canceled)

21. A method for providing a security mechanism for an external code, the method comprising:
receiving the external code comprising a request for a server specific bootstrapping key (Ks_NAF);
determining a server identifier (NAF-Id) and generating the server specific bootstrapping key (Ks_NAF) based on the server identifier (NAF-Id);
determining a security token;
generating an external code specific bootstrapping key (Ks_js_NAF) using the server specific bootstrapping key (Ks_NAF) and the security token; and
using the external code specific bootstrapping key (Ks_js_NAF) for the security mechanism of the external code.

22. The method of claim 21, further comprising determining the security token using a first random challenge (RAND1) and a second random challenge (RAND2).

23. The method of claim 22, further comprising:
transmitting the second random challenge (RAND2) and the external code specific bootstrapping key (Ks_js_NAF) to an application server for validation of the external code specific bootstrapping key (Ks_js_NAF).

24. The method of claim 23, wherein the transmitting step further comprising:
transmitting a response external code comprising the second random challenge (RAND2) and the external code specific bootstrapping key (Ks_js_NAF).

25. The method of claim 21, further comprising:
receiving the external code, by a browser application of an apparatus, from an application server;
determining the server identifier (NAF-Id) and the security token, by an application programming interface (JS-GBA-API) of the browser application;
requesting the server specific bootstrapping key (Ks_NAF) by the application programming interface (JS-GBA-API), from a bootstrapping module of the operating system;
receiving the server specific bootstrapping key (Ks_NAF) by the application programming interface (JS-GBA-API), from the bootstrapping module; and
generating the external code specific bootstrapping key (Ks_js_NAF) by the application programming interface (JS-GBA-API).

26. The method of claim 21, further comprising:
establishing a transport layer security (TLS) tunnel between a browser application of an apparatus and an application server; and
determining the server identifier (NAF-Id) including a domain name (FQDN) and a security protocol identifier.

27. The method of claim 26, wherein the security protocol identifier is formed using a ciphersuite of a transport layer security (TLS).

28. The method of claim 21, further comprising:
generating the external code specific bootstrapping key (Ks_js_NAF) with a key derivation function.

29. The method of claim 21, wherein the external code comprises a JavaScript code.

30. The method of claim 21, further comprising determining the security token using a transport layer security (TLS) master key.

31. An apparatus, comprising:
at least one processor; and
at least one memory including computer program code, the at least one memory and the computer program code being configured to, with the at least one processor, cause the apparatus at least to:
receive an external code comprising a request for a server specific bootstrapping key (Ks_NAF);
determine a server identifier (NAF-Id) and generate the server specific bootstrapping key (Ks_NAF) based on the server identifier (NAF-Id);
determine a security token;
generate an external code specific bootstrapping key (Ks_js_NAF) using the server specific bootstrapping key (Ks_NAF) and the security token; and
use the external code specific bootstrapping key (Ks_js_NAF) for a security mechanism of the external code.

32. The apparatus of claim 31, wherein the at least one memory and the computer program code being further configured to, with the at least one processor, cause the apparatus at least to:
determine the security token using a first random challenge (RAND1) and a second random challenge (RAND2).

33. The apparatus of claim 31, wherein the at least one memory and the computer program code being further configured to, with the at least one processor, cause the apparatus at least to:
receive the external code, by a browser application of the apparatus, from an application server;
determine the server identifier (NAF-Id) by an application programming interface (JS-GBA-API) of the browser application;
request the server specific bootstrapping key (Ks_NAF) by the application programming interface (JS-GBA-API), from a bootstrapping module of the operating system;
receive the server specific bootstrapping key (Ks_NAF) by the application programming interface (JS-GBA-API), from the bootstrapping module; and
generate the external code specific bootstrapping key (Ks_js_NAF) by the application programming interface (JS-GBA-API).

34. The apparatus of claim 31, wherein the at least one memory and the computer program code being further configured to, with the at least one processor, cause the apparatus at least to:
determine the security token using a transport layer security (TLS) master key.

35. A computer program embodied on a non-transitory computer readable medium comprising computer executable program code which, when executed by at least one processor of an apparatus, causes the apparatus to:
receive an external code comprising a request for a server specific bootstrapping key (Ks_NAF);
determine a server identifier (NAF-Id) and generate a server specific bootstrapping key (Ks_NAF) based on the server identifier (NAF-Id);
determine a security token;
generate an external code specific bootstrapping key (Ks_js_NAF) using the server specific bootstrapping key (Ks_NAF) and the security token; and
use the external code specific bootstrapping key (Ks_js_NAF) for a security mechanism of the external code.

36. A method for providing a security mechanism for an external code, the method comprising:
transmitting the external code, wherein the external code comprising a request for a server specific bootstrapping key (Ks_NAF);
determining a security token;
generating the server specific bootstrapping key (Ks_NAF) using a server identifier (NAF-Id);
generating an external code specific bootstrapping key (Ks_js_NAF) using the server specific bootstrapping key (Ks_NAF) and the security token; and
using the external code specific bootstrapping key (Ks_js_NAF) for the security mechanism of the external code.

37. The method of claim 36, further comprising:
requesting the server specific bootstrapping key (Ks_NAF) from a bootstrapping server function (BSF); and
determining the server identifier (NAF-Id) including a domain name (FQDN) and a security protocol identifier.

38. The method of claim 36, further comprising:
receiving an external code specific bootstrapping key (Ks_js_NAF);
validating the external code specific bootstrapping key (Ks_js_NAF) by comparing the generated external code specific bootstrapping key (Ks_js_NAF) to the received external code specific bootstrapping key (Ks_js_NAF) for the security mechanism of the external code.

39. An application server, comprising:
at least one processor; and
at least one memory including computer program code, the at least one memory and the computer program code being configured to, with the at least one processor, cause the application server at least to:
transmit an external code, wherein the external code comprising a request for a server specific bootstrapping key (Ks_NAF);
generate a server specific bootstrapping key (Ks_NAF) using a server identifier (NAF-Id);
determine a security token;
generate an external code specific bootstrapping key (Ks_js_NAF) using the server specific bootstrapping key (Ks_NAF) and the security token; and
use the external code specific bootstrapping key (Ks_js_NAF) for the security mechanism of the external code.

40. A computer program embodied on a non-transitory computer readable medium comprising computer executable program code which, when executed by at least one processor of an application server, causes the application server to:
transmit an external code, wherein the external code comprising a request for a server specific bootstrapping key (Ks_NAF);
generate a server specific bootstrapping key (Ks_NAF) using a server identifier (NAF-Id);
determine a security token;
generate an external code specific bootstrapping key (Ks_js_NAF) using the server specific bootstrapping key (Ks_NAF) and the security token; and
use the external code specific bootstrapping key (Ks_js_NAF) for the security mechanism of the external code.
